(19) United States
(12) Patent Application Publication
(10) Pub. No.: US 2005/0066905 A1
(43) Pub. Date: Mar. 31, 2005

(54) Automated pet feeder

(76) Inventors: Rose Chan Morosin, Morro Bay, CA (US); Michael Keith Morosin, Morro Bay, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/917,549

(22) Filed: Aug. 12, 2004

(30) Foreign Application Priority Data
Sep. 26, 2003 (CN) PF-01 03274710.1
Jun. 4, 2004 (CN) 200420046594.1

(51) Int. Cl. A01K 1/10

(52) U.S. Cl. 119/51.02

(57) ABSTRACT

An automated pet feeder is described that allows portions of pet food to be placed into cavities in a rotatable food bowl and to be made accessible to a pet at predetermined feeding times. A lid with an opening for exposing one of the cavities is positioned above the bowl. A base unit that supports the bowl is configured to rotate the bowl while the lid remains stationary and to monitor the position of the bowl. A timing mechanism controls rotation of the bowl and sequentially positions a next cavity under the opening at feeding times that may be set to occur at various time intervals or clock times that may be pre-programmed by a user. A sound system allows a user to record a voice or other sound recording that may be played at feeding times. In some embodiments, a reservoir may hold ice or an ice pack or other cooling material or apparatus to help keep the pet food fresh until it is made accessible, or the reservoir may be used to hold drinking water. Inserts may be used that are configured to fit into the cavities allow for the convenient use of disposable pet food packs and greatly reduce the need for washing the food bowl after use.

### PRIORITY APPLICATION

The present application claims priority benefit under 35 U.S.C. 119(a) to Patent Application No. 03274710.1 filed with the State Intellectual Property Office of the People's Republic of China on Sep. 26, 2003 and to Patent Application No. 200420046594.1 filed with the State Intellectual Property Office of the People's Republic of China on Jun. 4, 2004.

### BACKGROUND OF THE INVENTION

1. Field of the Invention

The present invention relates to pet feeders, and, more particularly, to automated pet feeders.

2. Description of the Related Art

Pet owners who must be away from their pets for an extended duration or whose busy schedule makes regular pet feedings difficult to carry out face a difficult situation. It is not always possible or convenient to arrange to have someone else take over feeding duties for the pet owner, and it is often not an acceptable choice to leave a large quantity of food available to the pet that is sufficient to last the duration of the owner's absence.

Automated pet feeders provide selected quantities of food to a pet at selected feeding times. However, automated pet feeders that drop food into a food dish at feeding times, which may be acceptable for serving dry pet food, do not work well for “wet” pet food. Owners may be especially desirous of serving food that is familiar and acceptable to their pet while they are away and may not be willing to switch to dry food for the duration of their absence. Furthermore, wet food that is left out for a pet may become spoiled if left for long periods of time at room temperature.

Other automated pet feeders with multiple covered bowls or stations for food that are automatically opened to provide access to the food may require the pet to stand in a different position for each station. Thus, the feeder may take up an inconveniently large amount of floor space and/or may need to be positioned away from a wall to allow access from all sides. In models where a bell or other sound is made to indicate the availability of additional food, the pet may not understand the significance of the sound or may take some time to learn the In addition, with currently available automated pet feeders, the pet may not be aware that a new portion of food has been dispensed by the pet feeder and may not come to eat. In significance of the sound, by which time, the pet owner's absence and need to have the pet automatically fed may have ended.

### SUMMARY OF THE INVENTION

An automated pet feeder is described that allows portions of pet food to be placed into cavities in a rotatable food bowl and to be made accessible to a pet at predetermined feeding times. A lid with an opening for exposing one of the cavities is positioned above the bowl. A base unit that supports the bowl is configured to rotate the bowl and to monitor the position of the bowl while the lid remains stationary. A timing mechanism controls rotation of the bowl and sequentially positions a next cavity under the opening at feeding times that may be set to occur at various time intervals or at a given time pre-programmed by a user. In some embodiments, a sound system allows a user to make a voice or other type of recording that may be played at feeding times to alert the pet to the availability of additional food. In some embodiments, a reservoir may hold ice, cool packs, or other suitable cooling material or temperature reducing mechanism or apparatus to help keep the pet food cool and fresh until it is made accessible, or the reservoir may be used to hold drinking water. Inserts may be used that are configured to fit into the cavities to allow for the convenient use of commercially available disposable pet food packs, thus greatly reducing the need for washing the food bowl after use. Because the bowl of the pet feeder rotates beneath a stationary lid, the pet may eat while standing in a single general position relative to the pet feeder for all of the feedings. Thus, the feeder may be located in a convenient location, such as in a corner of a room, while still providing the pet access to the food at the scheduled feeding times.

An embodiment of an automated pet feeder is described that comprises a rotatable bowl with multiple cavities to hold food for different meals; a lid that covers said cavities and that has an opening which exposes one cavity; a base unit configured to support the rotatable bowl; a rotary mechanism for rotating the rotatable bowl relative to the base unit while the lid remains stationary relative to the base unit; a timer configured to provide an indication of a next feeding time; and a control unit configured to receive the indication from the timer and to trigger, based at least in part on the indication, the rotary mechanism to rotate the bowl, positioning a next one of the cavities in the rotatable bowl under the opening in the lid for dispensing food stored therein.

An embodiment of a method of dispensing food for an animal is described. The method comprises the acts of: outputting a timer signal; running a motor, in response to receiving the timer signal, in order to advance a container of food under a lid that has an opening; and stopping the motor to position the container of food under the opening to permit food in the container to become accessible for dispensing to an animal.

An embodiment of a method of feeding an animal using an automated pet feeder is described. The method comprises the acts of: placing food into one or more cavities in a food bowl of an automated pet feeder; setting a timer on the automated pet feeder to indicate feeding times; placing a lid with an opening over the food bowl; and activating power to the automated pet feeder to cause the food bowl to rotate and to sequentially position the food in the cavities under the opening at the feeding times.

An embodiment of a system for automatically dispensing pet food to a pet is described. The system comprises: plural storing means for storing quantities of pet food to be dispensed at feeding times; timing means for determining feeding times; barrier means for obstructing access to selected ones of the storing means; and dispensing means responsive to the timing means for allowing the storing means to become accessible to the pet at selected feeding times.

An embodiment of an automated pet feeder is described. The automated pet feeder comprises: a dispensing mechanism that makes food available to a pet at predetermined feeding times, and a sound system configured to store a voice recording provided by a user and to play the voice recording at the feeding times.

An embodiment of an automated pet feeder is described. The automated pet feeder comprises: a dispensing mechanism that makes food available to a pet at predetermined feeding times, and a cooling apparatus for keeping the food cool until the predetermined feeding times.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages taught or suggested herein.

### BRIEF DESCRIPTION OF THE DRAWINGS

These and other features of the invention will now be described with reference to the drawings summarized below. These drawings and the associated description are provided to illustrate preferred embodiments of the inventions, and not to limit the scope of the invention. Like reference characters designate the same or similar parts throughout the several views.

FIG. 1 presents an exploded view of one embodiment of an automated pet feeder.

FIG. 2 depicts one embodiment of the automated pet feeder with the lid and secondary cover removed to reveal the bowl with four cavities for holding pet food.

FIG. 3 depicts one embodiment of the automated pet feeder with the secondary cover removed to reveal the lid body and sliding door.

FIG. 4 depicts a first embodiment of the automated pet feeder, fully assembled.

FIG. 5 depicts a second embodiment of the automated pet feeder, fully assembled.

FIG. 6A depicts a first embodiment of a control panel for the automated pet feeder.

FIG. 6B depicts a second embodiment of a control panel for the automated pet feeder.

FIG. 7 depicts one embodiment of a base unit with the cover removed, revealing the mechanism tray.

FIG. 8 depicts one embodiment of the pet feeder bowl with inserts in the cavities for holding disposable pet food packs.

FIG. 9A is a flow chart that depicts one embodiment of a method for automatically dispensing pet food under normal operation.

FIG. 9B is a flow chart that depicts one embodiment of a method for handling jams that occur while attempting to automatically dispense pet food.

### DETAILED DESCRIPTION OF THE PREFERRED EMBODIMENT

An automated pet feeder is described that allows portions of pet food for subsequent feeding to a pet to be placed into cavities in a rotatable food bowl. A lid with an opening for exposing one of the cavities is positioned above the bowl. A base unit that supports the bowl is configured to rotate the bowl while the lid remains stationary and to monitor the position of the bowl relative to the opening in the lid. A timing mechanism controls rotation of the bowl and sequentially positions a next cavity under the opening at predetermined feeding times.

In various embodiments, different numbers of food cavities may allow for different numbers of automated feedings to occur without additional intervention by a human user. Furthermore, a human user may set a time schedule for the automated feedings by a variety of methods, including specifying a desired time interval between feedings and specifying desired clock times for feedings. Embodiments are described that allow a user to make a sound recording to announce automated feedings in order to alert a pet to the availability of food and to encourage the pet to eat from the feeder. In one embodiment, a reservoir on the lid for holding ice helps to preserve the freshness of food placed in the cavities below. The reservoir may also be used for providing drinking water to a pet. Anti-jamming systems and methods allow various embodiments of the automated pet feeder to overcome obstructions to normal operation without the intervention of a human user.

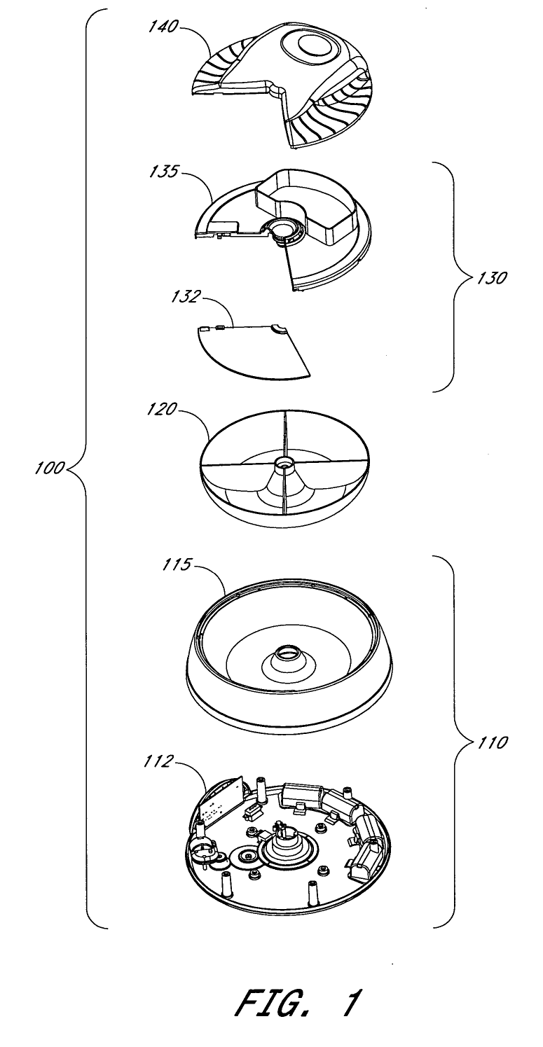

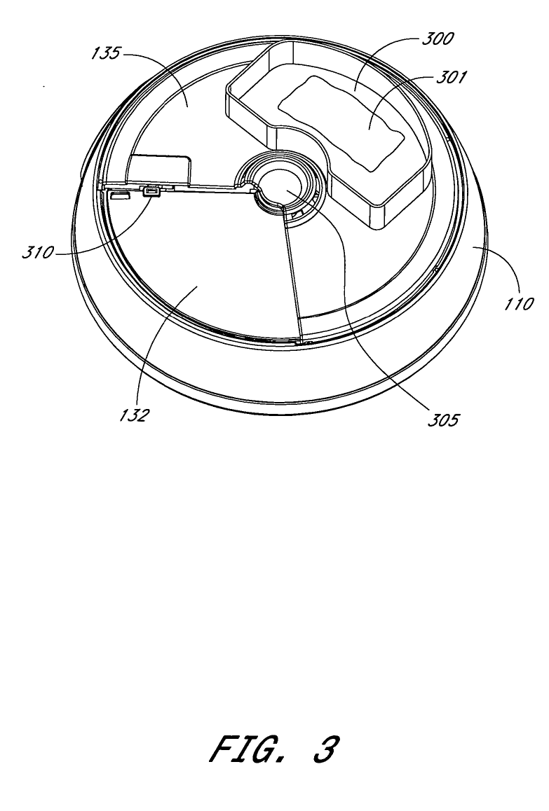

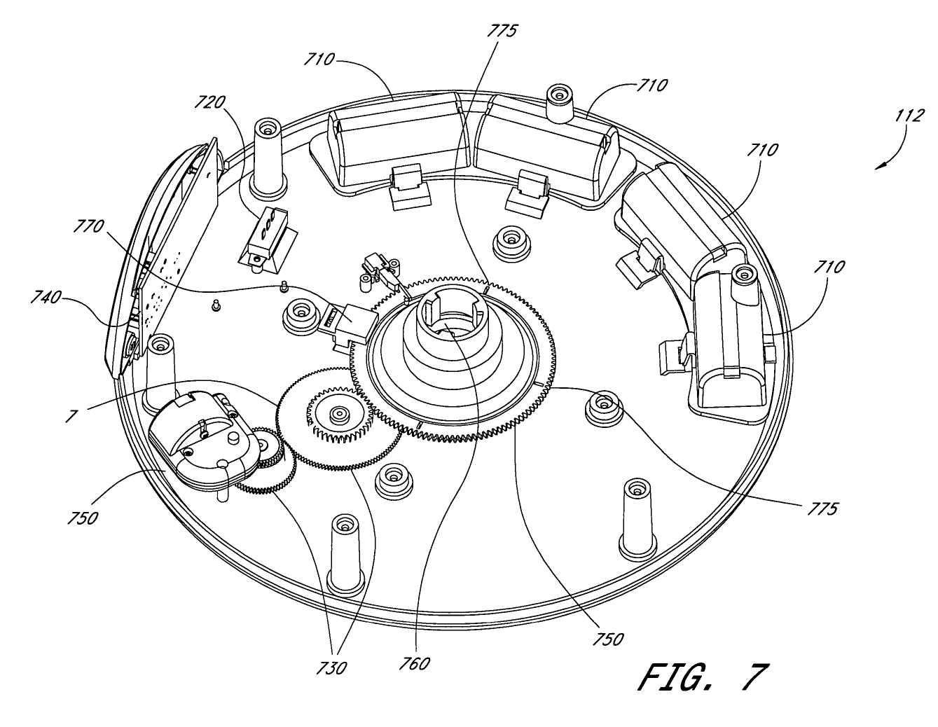

FIG. 1 presents an exploded view of one embodiment of an automated pet feeder 100. As shown in FIG. 1, the main components of the automated pet feeder 100 comprise a base unit 110, a bowl 120, a lid 130, and, in some embodiments, a secondary cover 140. The base unit comprises a mechanism tray 112 that contains mechanisms for providing power and control to the automated pet feeder 100 and that will be described in greater detail with reference to FIG. 7 below. The base unit 110 also comprises a base unit cover 115 that protects the mechanism tray 112 and that is shaped to support the food bowl 120. The lid 130 of the automated pet feeder 100 comprises a lid body 135 and a sliding door 132 and will be described in greater detail with reference to FIG. 3 below.

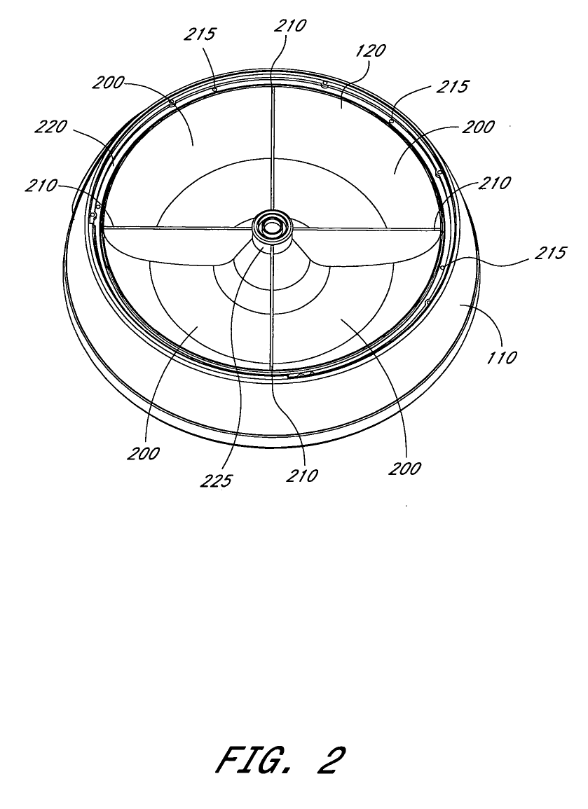

FIG. 2 depicts one embodiment of the automated pet feeder 100 with the secondary cover 140 and lid 130 removed to reveal the bowl 120 seated in the base unit 110. The bowl 120, thus seated, is free to rotate about a central column 225.

In the embodiment depicted in FIG. 2, the bowl 120 is divided by four cavity walls 210 into four cavities 200 for holding pet food. In other embodiments of the automated pet feeder 100, the bowl 120 may be divided into another number of cavities 200. In currently preferred embodiments, the number of cavities 200 in the bowl 120 ranges from three to six cavities 200.

In some embodiments, numerals (not shown) or other symbols uniquely identifying the cavities 200 may be embossed and/or printed on the bottom of the cavities 200 and/or around a central column 225 of the bowl to help indicate to a human the order in which the cavities 200 will be presented to a pet. Thus, the user may more easily provide a sequence of differing meals at feeding times, if desired.

Also depicted in FIG. 2 is a rim 220 that surrounds a top inner circumference of the base unit 10 and that engages a curved, downward projecting lip (not shown) of the lid body 135 and a curved, downward projecting lip of the sliding door 132, as will be described in greater detail with reference to FIG. 3. In addition, FIG. 2 shows the placement of multiple positioning holes 215 in the rim 220 that accept appropriately placed pin-like protrusions (not shown) projecting downwards from an underside of the lid body 135, which help to anchor the lid body 135 in a stationary position relative to the base unit 110 without obstructing the free rotation of the bowl 120.

FIG. 3 depicts one embodiment of the automated pet feeder 100 with the secondary cover 140 removed to reveal the lid body 135 and sliding door 132. As described above, the lid body 135 may be held in a stationary position with respect to the base unit 110 with the help of the rim 220 and positioning holes 215 of the base unit 110. Furthermore, a column-shaped projection (not shown) that extends downwards from a central portion 305 of the lid body 135 is configured to rotatably fit into a circular depression at the top of the bowl's 120 central column 225, helping to secure the position of the lid 130 while allowing the bowl 120 to rotate.

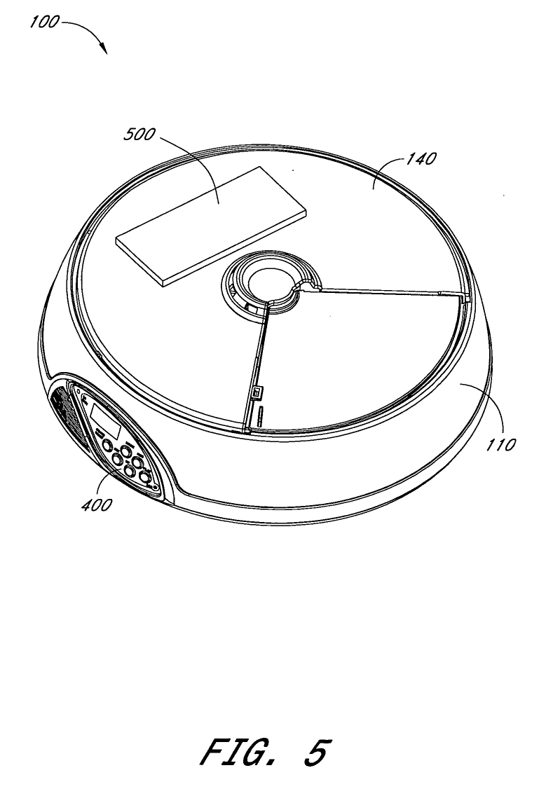

In the embodiment shown in FIG. 3, the lid body 135 further comprises a reservoir 300 that may hold ice, a cool-pack 301, or other suitable material or temperature reducing mechanism or apparatus for preserving the freshness of food, especially wet food, placed in the cavities 200 below. For example, a Peltier or other thermoelectric (TE) module connected to a power source may be used to reduce the temperature in the pet feeder 100. FIG. 5 depicts the use of a Peltier module 500 with an embodiment of the pet feeder 100 that does not comprise a reservoir 300. In the embodiment shown in FIG. 3, the reservoir 300 is sized and shaped to hold a standard 250 gram “blue ice pack” 301. In other embodiments, the reservoir 300 may be shaped to substantially cover the lid body 135 or may be otherwise shaped, or more than one reservoir 300 may be included. In some embodiments with four cavities 200, the reservoir 300 may initially be positioned over the second and third cavities 200. As the bowl 120 rotates beneath the lid body 135, the third and fourth cavities 200 may be positioned beneath the reservoir. In some embodiments, human users of the automated pet feeder 100 who select feeding times with relatively long intervening time intervals are advised to use wet food, if desired, in one or both of the first and second cavities, while putting dry pet food in the third and fourth cavities. Thus, if ice or an ice pack in the reservoir 300 will not be sufficient to cool the pet food for the entire duration of the pet owner's absence, the owner may, for safety's sake, provide cooled pet food for a first subset of the feedings and dry pet food, which will not spoil quickly, for a second subset of the feedings.

In some embodiments where ice or an ice pack is used, the lid body 135 may further comprise vents (not shown) in the lid body 135 that allow cooler air from between the lid body 135 and the secondary cover 140 to pass down onto the cavities 200 of the food bowl 120.

The reservoir 300 may also be used to hold drinking water for a pet when no secondary cover 140 is placed over the reservoir 300. Furthermore, in some embodiments, the pet feeder may be used without the secondary cover 140 to allow heat from a TE unit 500 placed in the reservoir 300 to escape up and away from the food cavities 200.

As shown in FIG. 3, the lid body 135 is shaped to partially cover the bowl 120 below. The sliding door 132 is shaped such that, when the sliding door 132 is in a closed position, the sliding door 132 covers any portion of the bowl's 120 surface area left exposed by the lid body 135. In preferred embodiments, the lid body 135 is shaped to cover all but one of the cavities 200 of the bowl 120. For example, in an embodiment in which the bowl 120 is divided into four cavities 200, the lid body 135 is shaped to cover three-fourths of the surface area of the bowl 120, leaving one cavity 200 exposed at any given time when the sliding door 132 is in an open position.

FIG. 3 depicts the sliding door 132 in a closed position. Like the lid body 135, the sliding door 132 comprises a curved, downward projecting lip (not shown) that sits on the rim 220 of the base unit 110. The sliding door 132 also comprises a curved, downward lip (not shown) that engages a circular channel in the central column 225 of the bowl 120. Unlike the lid body 135, the sliding door 132 does not engage the positioning holes 215 of the base unit 110. The sliding door 132 is free to be rotated independently of the lid body 135.

A latch mechanism 310 on the sliding door 132 is configured to engage a hook mechanism (not shown) on the underside of the lid body 35. After filling the food cavities 200 with food, a user may position the lid body 132 and the sliding door 132 to cover all of the cavities 200 of the food bowl 120, and may latch the sliding door 132 closed using the latch mechanism 310 and the hook mechanism. When the bowl 120 is next rotated, as will be described in greater detail with reference to FIG. 7, the cavity wall 210 that next passes under the latching mechanism 310 pushes up on a protrusion (not shown) on the underside of the sliding door 132, pushing the latching mechanism 310 up and off the hook mechanism and pushing the sliding door 132 to slide under the lid body 135, thereby exposing the cavity below the opening in the lid body 135.

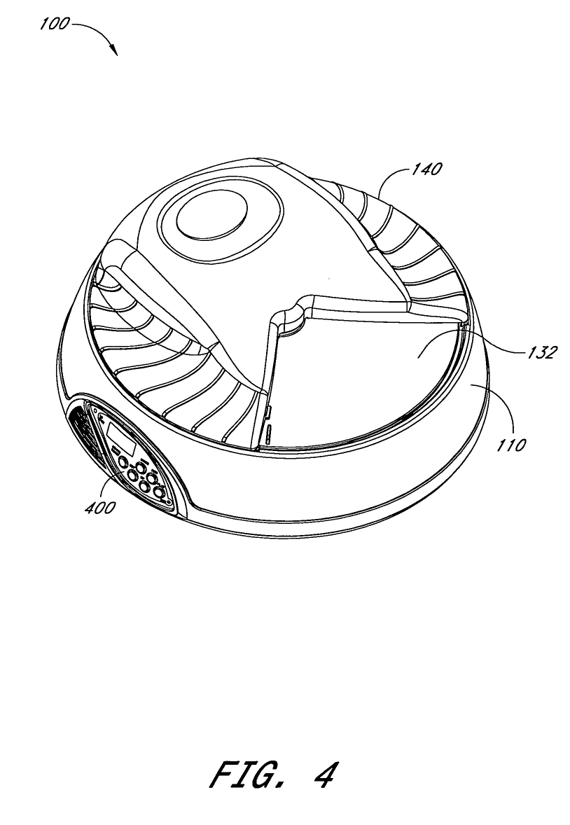

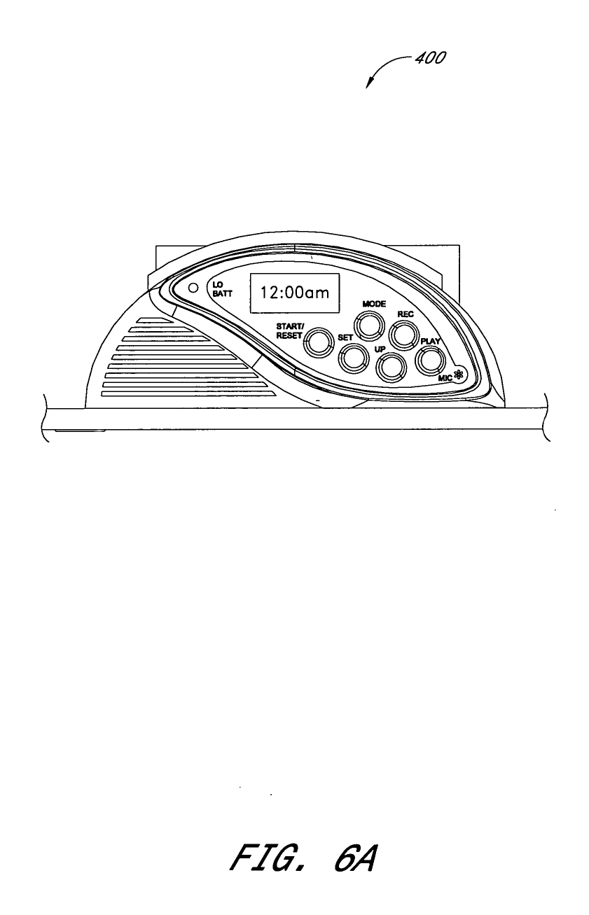

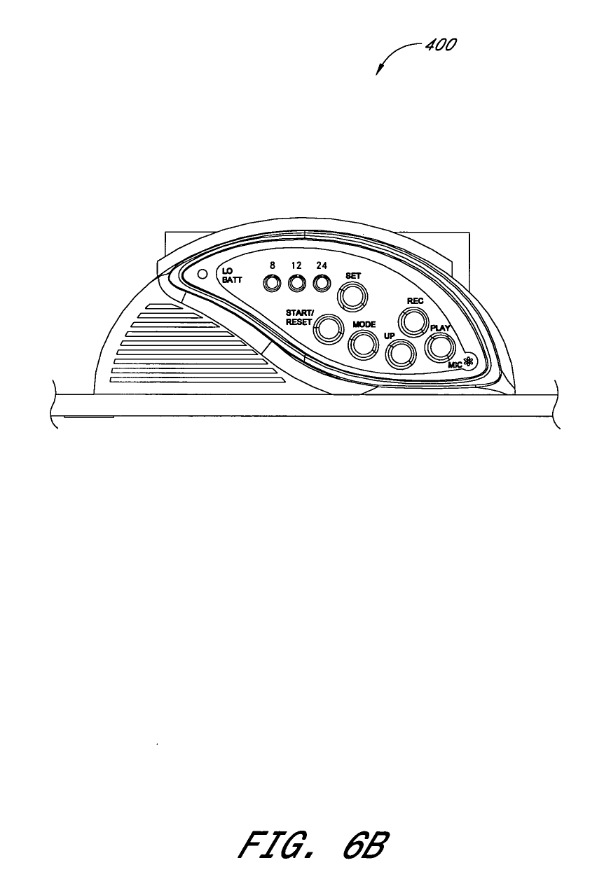

FIG. 4 depicts one embodiment of the automated pet feeder 100, fully assembled and with the secondary cover 140 attached over the lid body 135. The secondary cover 140 is thus able to help retain the coldness of any ice or ice pack in the reservoir 300 and to provide a more aesthetic covering to the pet feeder 100. As shown in FIG. 4, the base unit 110 further comprises a control panel 400, which will be described in greater detail with reference to FIGS. 6A and 6B.

FIG. 5 depicts a second embodiment of the automated pet feeder 100, fully assembled. In contrast to the embodiment shown in FIG. 4, the embodiment shown in FIG. 5 does not comprise a secondary cover, nor does the lid body 135 comprise a reservoir. Instead, the lid body 135 and sliding door 132 present a substantially flat top to the pet feeder 100. As shown in FIG. 5, in some embodiments, a Peltier or other thermoelectric (TE) module 500 may be placed on the lid body 135 to cool the temperature of the food in the cavities 200 below. By placing the TE module 500 with its cooling side facing the cavities 200, heat generated by the TE module 500 may be directed up and away from the automated pet feeder 100.

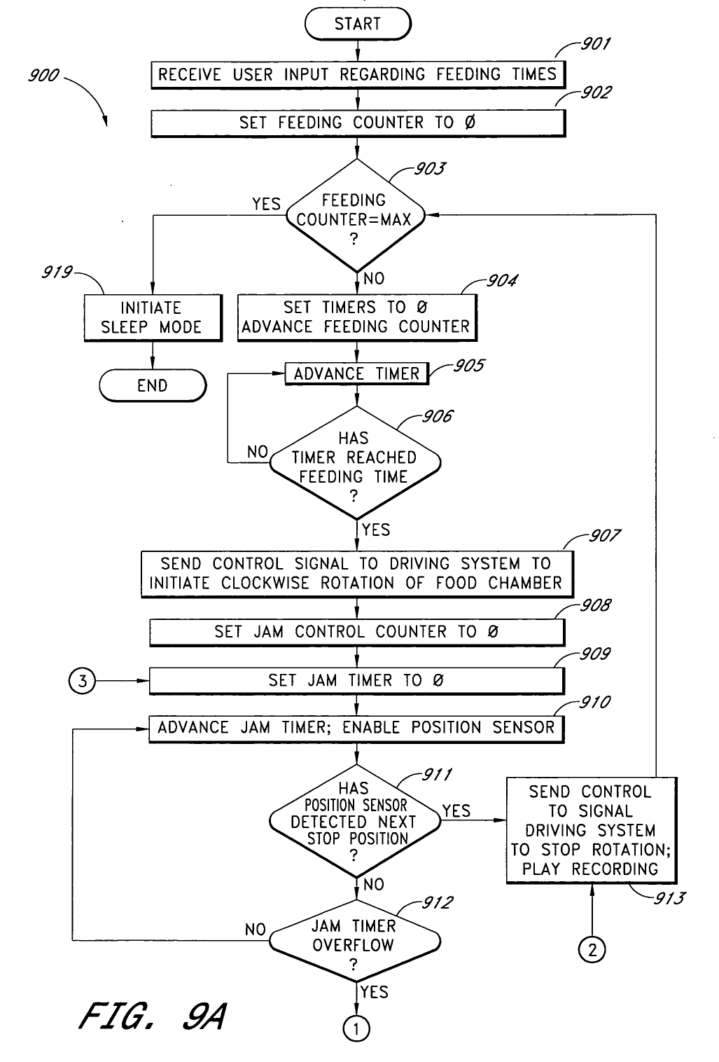

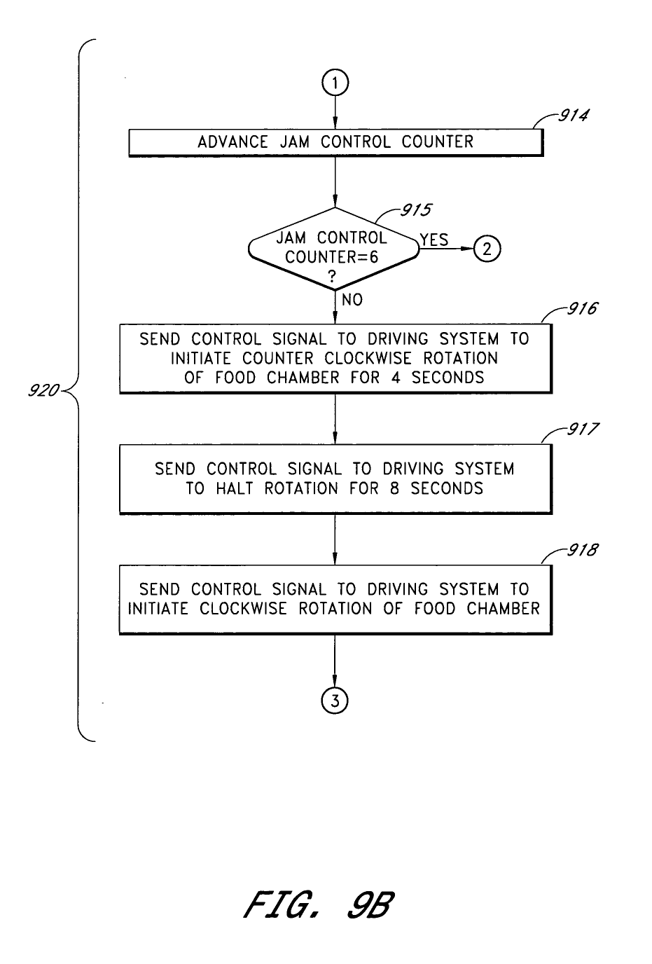

FIGS. 6A and 6B depict two embodiments of a control panel 400 for the automated pet feeder 100 that allow the user to program desired times at which food the feeding bowl 120 will be rotated to make a new cavity 200 with food accessible for feeding. The control panel 400 in FIG. 6A comprises an LCD panel that allows a user to set a specific time at which food will be dispensed by the pet feeder 100 in much the same way that digital alarm clocks may be set to ring at a given time. A MODE button allows the user to switch between setting the current clock time and setting feeding times, using a SET button and an UP button to make the desired changes. In a feeding time mode, the user may be prompted, by indicators on the LCD panel to set a feeding time for making each food cavity 200 accessible to the pet. Pressing the SET button after desired clock time or feeding times have been set allows the clock and timers (described in greater detail with reference to FIGS. 9A and 9B) to operate normally. In embodiments in which the user sets feeding times with an LCD clock, the control panel 400 may allow the user to set a feeding time for each cavity 200 of food in the food bowl 120. Embodiments with LCD clocks may display time using a twelve-hour or a twenty-four hour clock display.

In some embodiments, such as one depicted in FIG. 6B, the user may set feeding times according to intervals of time between feedings instead of using clock times. In one such embodiment, in addition to or as an alternative to the LCD clock, the control panel 400 comprises radio-style buttons that allow the user to select time intervals of eight, twelve, or twenty-four hours between feedings. In other embodiments, intervals of other lengths may be offered, or a numerical keypad may allow users to enter interval lengths of their own choosing. In some embodiments, the control panel 400 may provide opportunity for the user to choose between options to set feeding times using time intervals or using clock time. In one embodiment, feeding times occur at preset intervals that are not programmable by the user.

A START/RESET button on the control panel 400 allows a user to initiate a new set of feedings. In one embodiment, buttons labeled START NOW and START TOMORROW (not shown) allow the user to elect whether the feeding timer should begin timing immediately upon pressing of the START/RESET button, or whether the feeding timer should be set to begin timing at midnight. If a user does not set desired feeding time or desired feeding time intervals, the automated pet feeder 100 may use default settings, such as an interval between feeding times of eight hours or a feeding time of midnight for each food cavity 200.

The control panel 400 may further comprise a recording mechanism that allows the user to record a voice or other audio recording, such as a 20-second recording, that is played by the pet feeder 100 when food is dispensed. Thus, a pet-owner may record a message to the pet, calling the pet to eat in a manner to which the pet is accustomed, which may encourage and remind the pet to eat while the pet-owner is away. Embodiments that include a recoding mechanism include well-known components such as, for example, a record button for recording an audio clip, a play button for testing the recorded clip, a microphone for receiving the message or other sound for recording, and a speaker to allow the pet to hear the sound. In other embodiments, the pet feeder 100 may make a sound audible to the pet to indicate that food is available at the pet feeder. For example, the pet feeder 100 may sound a bell or provide to the user a choice of pre-set sounds to announce feeding times.

FIG. 7 depicts one embodiment of a base unit 110 with the base unit cover 115 removed, revealing the mechanism tray 112. The mechanism tray 112 comprises one or more battery cabinets 710 for holding batteries that power the automated pet feeder 100 and a power switch 720 that allows power from the batteries to flow or to be interrupted from flowing to a main control unit (MCU) 740 that is programmed, in part, to control power to a driving system 750 that drives a bowl driving gear set 730 with one or more reduction gears. While FIG. 7 depicts one possible configuration of the bowl driving gear set 730, other configurations are also possible in other embodiments. The bowl driving gear set 730 in turn drives a ring gear 755 attached to a drive pedestal 760. The drive pedestal 760 rotatably supports the food bowl 120 and may be attached thereto by a releasable latch into which the food bowl 120 may be engaged, thus causing the food bowl 120 to rotate when a gear shaft in the drive pedestal 760 rotates.

The MCU 440 further controls and monitors one or more position sensors 770, which are used to determine a precise position of the food bowl 120 with reference to the opening in the lid body 135. In a preferred embodiment, an optical sensor 770 uses a photo-coupler to detect when light passes through holes 775 in the ring gear 755 that correspond to the number and position of cavities 200 in the food bowl. The optical sensor 770 transmits messages that may be used by the MCU 440 to determine if the rotating food bowl 120 is properly aligned or if it has become stuck, due, for example, to jammed food. FIGS. 9A and 9B describe in greater detail normal operation of the pet feeder 100 as controlled by the MCU 740 as well as an anti-jamming procedure that provides a great advantage to pet owners who want to be assured that the pet feeder 100 will reliably deliver food to their pet as scheduled while they are away.

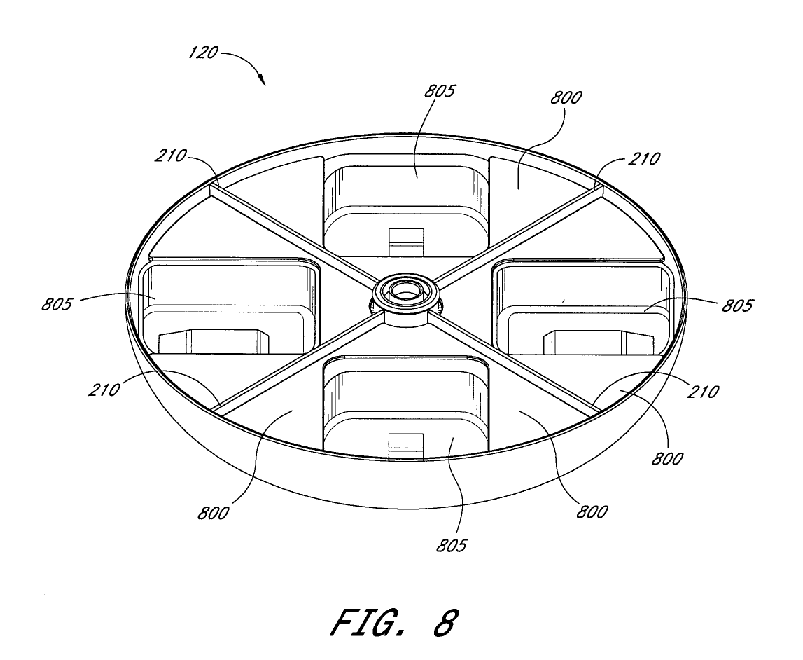

FIG. 8 depicts an adaptation to the food bowl 120 that allows for the use of commercially available disposable packs of wet pet food in connection with the automated pet feeder 100. The disposable packs are frequently made from a metallic foil material and have a seal portion that may be pulled off to provide access to the pet food inside. FIG. 8 depicts one embodiment of the food bowl 120 wherein inserts 800 have been positioned within the cavities 200 of the food bowl 120. Each insert 800, which may be formed from plastic or other suitably rigid material, comprises a recessed portion 805 that is shaped to supportably hold a disposable food pack. A human user may thus remove the seals from disposable packs of pet food, place the opened food packs into the recessed portions 805 of the inserts 800, and use the automated pet feeder 100 in a normal fashion. When the user wishes to empty the pet feeder 100, the user simply removes the empty disposable packs from the inserts 800 and disposes of them, with no need to wash the food bowl 120.

FIGS. 9A and 9B present one embodiment of a procedure 900 for automatically dispensing pet food using the automated pet feeder 100, including procedures for handling jams that may occur.

The procedure 900 begins at a start state when a user presses a start/reset button on the control panel 400. In Block 901 the MCU 740 receives and stores user input regarding desired feeding times. As was described with reference to FIGS. 6A and 6B, according to two contemplated methods, feeding times may be indicated as a desired interval length of time between feedings or as a clock times at which food is to be dispensed. The embodiment depicted in the flowchart of FIGS. 9A and 9B use the time interval method. However, as will be familiar to one of ordinary skill in the art, re-configuring the p 900 to accept feeding time specifications such as clock times may be accomplished without undue experimentation on the part of the practitioner.

Block 902 sets a Feeding Counter to zero, indicating that no feedings have yet been dispensed since the start/reset button was pushed. Block 903 tests to see if the Feeding Counter is yet at a maximum number of feedings available for a given configuration of food cavities 200. For example, the four food cavities 200 of the embodiment shown in FIG. 2 indicate that a maximum of four feedings may be dispensed from one filling of the food bowl cavities 20, while an embodiment with five food bowl 120 cavities 200 allows for five feedings. If the maximum number of feedings have not already been dispensed, the procedure 900 for automatically dispensing pet food continues.

Block 904 initializes a Timer counter, which counts time to see when the desired feeding interval has been reached, and sets a JamCounter to zero, indicting that no jams have yet occurred. In block 904, the MCU 740 further increments the FeedingCounter by one.

Blocks 905 and 906 allow the MCU 740 to keep track of time until the desired time interval has passed.

In Block 907, when a feeding time has arrived, the MCU 740 sends a control signal to the driving system, activating the drive motor 750 to rotate the gear set 730 and the ring gear 755, and to thereby initiate a clock-wise rotation of the food bowl 120.

Blocks 908-912 allow the MCU 740 to monitor the movement of the food bowl in two ways. For one, the position sensor 770 is monitored to determine if it has had a photo-coupler reading indicating that the food bowl 120 is properly positioned for the next feeding with a next food cavity 200 positioned under the opening in the lid body 135. A second method of monitoring provides a backup in case the food bowl 120 has become jammed on one or more pieces of food or for some other reason. According to this method, the MCU 740 uses the JamTimer to keep track of elapsed time since the driving system last began rotating the food bowl 120. A time value in seconds that is just longer than the expected time for properly re-positioning the food bowl 120, for example sixty-eight seconds, is allotted for rotation of the food bowl 120 before a timer overflow/error condition is sensed at Block 912, which sets in motion jam control measures 920 that will be described with reference to FIG. 9B.

Meanwhile, if in Block 911 the MCU 740 receives a signal that the optical position sensor 770 has been triggered, indicating that the food bowl 120 is positioned to allow access to a newly-positioned cavity 200 with food, in Block 913, the MCU 740 sends a control signal to the driving system 750 for stopping rotation, and, in embodiments with sound system capabilities, for playing a recording by the pet-owner or other sound to notify the pet of available food.

From Block 913, the procedure 900 returns to Block 903, where the MCU 740 again checks if the FeedingCounter indicates that a final feeding has been made. If a final feeding has not been made, the procedure 900 continues for a next feeding, advancing through Blocks 904-913. If the MCU 740 determines that a final feeding has been made, the MCU 740 may, as described in Block 919, shut down non-essential functions of the automated pet feeder 100 and initiate a sleep mode in which power consumption may be reduced until the user again desires to interact with the automated pet feeder 100.

Moving on now to FIG. 9B, if while waiting for an optical sensor message indicating proper alignment of the food bowl 120, the JamTimer indicates at Block 912 that an excessive amount of time has elapsed for rotation of the food bowl 120, the MCU 740 may initiate jam control procedures 920.

In Block 914, the MCU 740 increments the JamControlCounter, indicting that an additional jam has occurred. The MCU 740 next determines whether this is the sixth attempt to implement jam control procedures. According to the embodiment illustrated in FIGS. 9A and 9B, the MCU 740 is programmed to allow a maximum of five attempts at un-jamming. In the event that five attempts are not successful, the MCU 740 is programmed to cease attempting to un-j am the food bowl 120 until the next scheduled feeding time occurs.

If five attempts to un-jam the food bowl 120 have not yet been made, the MCU 740 attempts to un-jam the food bowl 120 by initiating a brief counter-clockwise rotation of the food bowl 120, followed by a return to forward rotation, as described in Blocks 916-918. Normal operation is again attempted, as indicated by a return to Block 909.

It will be understood that each of the elements described above, or two or more together, may also find a useful application in other types of constructions differing from the types described above.

While the invention has been illustrated and described as embodied in an automated pet feeder, however, it is not limited to the details shown, since substitutions and changes in the forms and details of the device illustrated and its operation can be made by those skilled in the art without departing in any way from the spirit of the present invention. Accordingly, the scope of the present invention is intended to be defined only by reference to the appended claims.

1. An automated pet feeder, comprising:
a rotatable bowl with multiple cavities to hold food for different meals;
a lid that covers said cavities; wherein said lid comprises an opening that exposes one cavity;
a base unit configured to support said rotatable bowl and said lid;
a rotary mechanism for rotating said rotatable bowl relative to said base unit, while said lid remains stationary relative to said base unit;
a timer configured to provide an indication of a next feeding time; and
a control unit configured to receive said indication from said timer and to trigger, based at least in part on said indication, said rotary mechanism to rotate said bowl, positioning a next one of said cavities in said rotatable bowl under said opening in said lid for dispensing food stored said cavity.

2. The automated pet feeder of claim 1, further comprising a reservoir in proximity to at least one of said cavities for holding a cooling material to help preserve the freshness of food in said cavities.

3. The automated pet feeder of claim 1, further comprising a reservoir in proximity to at least one of said cavities for holding a temperature reducing apparatus to help preserve the freshness of food in said cavities.

4. The automated pet feeder of claim 1, further comprising a cover to fit over said lid and said reservoir.

5. The automated pet feeder of claim 1, wherein said rotatable bowl has three cavities for holding food.

6. The automated pet feeder of claim 1, wherein said rotatable bowl has five cavities for holding food.

7. The automated pet feeder of claim 1, wherein said timer is configured to provide an indication at fixed time intervals.

8. The automated pet feeder of claim 7, wherein said timer may be set to provide an indication every eight, twelve, or twenty-four hours.

9. The automated pet feeder of claim 1, wherein said control unit, after triggering said rotary mechanism to rotate said bowl, is further configured to wait until a next timing indication from said timer.

10. The automated pet feeder of claim 1, wherein said lid further comprises a sliding door that may be positioned to cover said opening.

11. The automated pet feeder of claim 10, wherein said lid and said door may be detachably connected with a latching mechanism that detaches when said rotary bowl rotates.

12. The automated pet feeder of claim 1, wherein said lid further comprises a reservoir for holding drinking water or for holding material to help preserve the freshness of food in said multiple cavities.

13. The automated pet feeder of claim 1, further comprising a control panel affixed to said base unit.

14. The automated pet feeder of claim 13, wherein said control panel includes a programmable LCD clock configured to accept feeding time settings, and wherein said timer may be set to provide an indication at feeding times set using said LCD clock.

15. The automated pet feeder of claim 13, wherein said control panel includes a control mechanism configured to accept a desired time interval setting from a user, and wherein said timer may be set to provide an indication at feeding times set using said control mechanism.

16. The automated pet feeder of claim 1, further comprising a sound system for making a sound audible to a pet at said feeding time.

17. The automated pet feeder of claim 16, said sound system further comprising a recording system for recording an audio clip and for playing said audio clip at said feeding time.

18. The automated pet feeder of claim 1, further comprising a position sensor configured to sense said bowl's position, said position sensor further configured to provide an indication to said control unit when said next cavity is positioned for dispensing food; and
said control unit further configured to receive said indication from said position sensor and to trigger, based at least in part on said indication, said rotary mechanism to stop rotating.

19. The automated pet feeder of claim 18, wherein said control unit is further configured to receive an indication from said position sensor when said rotatable bowl stops rotating in a first direction, and wherein, if said indication signifies that said rotary bowl has stopped before a next cavity is positioned for dispensing food, said control unit is configured to cause said rotary mechanism to: (a) rotate said rotary bowl in a direction opposite to said first direction for a first fixed duration of time, (b) stop rotating for a second fixed duration of time, and (c) resume rotating said rotary bowl in said first direction.

20. The automated pet feeder of claim 19, wherein said first time interval is four seconds and wherein said second time interval is eight seconds.

21. The automated pet feeder of claim 19, wherein if, after executing steps (a), (b), and (c), said control unit receives an indication from said position sensor signifying that said rotary bowl has stopped before said next cavity is positioned for dispensing food, said control unit is configured to cause said rotary mechanism to repeat steps (a), (b), and (c).

22. The automated pet feeder of claim 21, wherein said control unit is further configured, while continuing to receive an indication from said position sensor signifying that said rotary bowl has stopped before said next cavity is positioned for dispensing food, to execute steps (a), (b), and (c) a fixed number of times before (c) causing said rotary mechanism to stop rotating said bowl and (d) waiting for a next indication from said timer.

23. The automated pet feeder of claim 1, wherein said control unit is further configured to undertake anti-jamming procedures when said rotary mechanism fails to rotate said bowl to allow said next one of said cavities in said rotatable bowl to dispense food stored therein.

24. The automated pet feeder of claim 1, further comprising inserts configured to fit into said cavities, said inserts shaped to supportably hold a disposable pet food pack.

25. A method of dispensing food for an animal, comprising:
outputting a timer signal;
running a motor, in response to receiving said timer signal, to advance a container of food under a lid that has an opening; and
stopping said motor to position said container of food under said opening to permit food in said container to become accessible for dispensing to an animal.

26. A method of feeding an animal using an automated pet feeder, said method comprising:
placing food into one or more cavities in a food bowl of an automated pet feeder;
setting a timer on said automated pet feeder to indicate feeding times;
placing a lid with an opening over said food bowl; and
activating power to said automated pet feeder to cause said food bowl to rotate and to sequentially position said food in said cavities under said opening at said feeding times.

27. The method of claim 26, further comprising recording a sound recording using said automated pet feeder for playing at said feeding time.

28. The method of claim 26, further comprising placing a cooling material in said automated pet feeder for helping to preserve the freshness of said food.

29. The method of claim 28, wherein said cooling material is ice.

30. The method of claim 28, wherein said cooling material is a “blue ice” cooling pack.

31. The method of claim 26, further comprising activating a cooling mechanism in said automated pet feeder for helping to preserve the freshness of said food.

32. The method of claim 31, wherein said cooling mechanism is a Peltier module.

33. A system for automatically dispensing pet food to a pet, said system comprising:
plural storing means for storing quantities of pet food to be dispensed at feeding times;
timing means for determining feeding times;
barrier means for obstructing access to selected ones of said storing means; and
dispensing means responsive to said timing means for allowing said storing means to become accessible to said pet at selected feeding times.

34. The system of claim 33, further comprising anti-jamming means for correcting obstructions affecting said dispensing means.

35. An automated pet feeder that comprises: a dispensing mechanism that makes food available to a pet at predetermined feeding times, and a sound system configured to store a voice recording provided by a user and to play said voice recording at said feeding times.

36. An automated pet feeder that comprises: a dispensing mechanism that makes food available to a pet at predetermined feeding times, and a cooling apparatus for keeping said food cool until said predetermined feeding times.

37. The automated pet feeder of claim 36, wherein said cooling apparatus comprises a reservoir and a cooling material.

38. The automated pet feeder of claim 36, wherein said cooling apparatus comprises a thermoelectric module.
